(19) United States
(12) Patent Application Publication
(10) Pub. No.: US 2003/0064128 A1
(43) Pub. Date: Apr. 3, 2003

(54) Mold with contoured cooling channels

(76) Inventor: Dennis S. Byrnes, Lancaster, PA (US)

Correspondence Address: Robert E. Cannuscio, DRINKER BIDDLE & REATH LLP, One Logan Square, 18th & Cherry Street, Philadephia, PA, 19103-6996, US

(21) Appl. No.: 10/238,327

(22) Filed: Sep. 9, 2002

Related U.S. Application Data
(60) Provisional application No. 60/318,137, filed on Sep. 7, 2001.

(51) Int. Cl. B29C 33/04; B29C 45/73

(52) U.S. Cl. 425/552; 249/79

(57) ABSTRACT

A mold for use in an injection mold assembly. The mold includes a cast mold member or housing with an internal cooling chamber. The cooling chamber has at least one mold wall with a first surface on one side of the wall and a second surface on the opposite side of the wall from the first surface. The wall has a substantially uniform wall thickness. A central plug is located inside the cooling chamber and is spaced apart from the second side of the wall. A channel is located between the wall and the central plug. The channel extends sustantially from one end to the other end of the cooling chamber. Inlet and outlet conduits are formed in one end of the cooling chamber for channeling fluid into and out of the cooling chamber.

### CROSS-REFERENCE TO PROVISIONAL APPLICATION

The present application is related to and claims priority from U.S. Provisional Patent Application Serial No. 60/318,137, filed Sep. 7, 2001, which is incorporated herein by reference in its entirety.

### FIELD OF THE INVENTION

The present invention relates to the field of molding and, in particular, to a mold for providing forming and cooling of contoured or irregularly shaped components and a method of making the same.

### BACKGROUND OF THE INVENTION

Injection molded and cast parts are prevalent in today's society. Such parts are made by injecting or otherwise channeling non-solidified liquid material into a cavity formed in a mold. The mold cavity defines the outer and inner contour/surface of the final product. The liquid is cooled while in the mold and then removed. This process can be used to form metal, plastic, rubber, composite and other types of materials into almost any shape. Plastic is the most typical material used in injection molding.

Conventional injection molds generally consist of two mold halves which are separatable from one another. Each mold half typically defines the external contour of half of the part being molded. For hollow components, the mold half might also define the inner contour of half of the part being molded. Alternatively, for hollow items, an internal or core mold may be inserted into the cavity to set or define the internal surface of the molded part.

In a typical injection molding process, the non-solidified material is injected into an empty mold cavity. The hot, non-solidified material rapidly flows throughout the void between the mold halves filling the cavity. Since the mold is cooler than the injected material, the temperature of the material will begin to drop as soon as the material contacts the walls of the mold cavity.

In order to speed up the cooling process, the molds are generally formed with cooling lines or jackets in the wall. To date, the cooling lines in the walls have been formed by drilling straight lines into the molds which are as close to the mold contour as possible. For straight molded parts, this concept is generally fine. However, for curved or irregularly shaped components, such conventional channels inefficiently cool the molded part. Also, it is not possible to machine in cooling chambers or channels in certain places due to limitations of metal cutting machinery. In order to provide more precise cooling in such irregular shaped molds, a large number of channels are drilled or machined into the mold in an attempt to get the water closer to the mold contour. The result is a tedious and time consuming process, necessitating that many of the drilled holes be subsequently filled and/or plugged. Even with all this expensive and laborious work, the cooling channels formed by this conventional process are still a series of straight conduit segments.

One of the problems that results from straight cooling channels adjacent to a non-linear contoured mold is that non-uniform or uneven cooling (i.e., local hot spots) will result. Since the final product being removed from the mold must be sufficiently cooled for it to maintain its desired form, non-uniform parts, with inefficient cooling must be left in the mold longer until all portions of the part are sufficiently cooled. This results in increased cooling time. The additional cooling time, in turn, results in an increase in the overall cost for the part. Also, uneven cooling can lead to the generation of undesirable stresses and strains in the part, such as residual stresses. These internal loadings can adversely affect the strength or life of the part.

One example for which conventional molding techniques are not efficient is in the molding of elbow components for PVC piping. The assignee of the present invention has developed unique molded plastic parts which are described in U.S. Pat. Nos. 6,179,343 and 6,256,961. In order to use conventional molding techniques, the time required to sufficiently cool these parts is high which results in increased costs for producing the part.

A need, therefore, exists for an improved cooling technique for injection and similar molded processes.

### SUMMARY OF THE INVENTION

The present invention relates to a mold for use in an injection mold assembly. The mold is operative for defining at least a portion of a surface contour of an injection molded part. In one embodiment of the invention the mold is an inner mold core for use in forming a hollow molded part.

The mold includes a mold member or housing with an internal cooling chamber. The cooling chamber has at least one mold wall with a first surface on one side of the wall and a second surface on the opposite side of the wall from the first surface. The first and second surfaces have substantially complementary contours so as to define a substantially uniform wall thickness. The cooling chamber has opposed first and second ends.

A central plug is located inside the cooling chamber and is spaced apart from the second side of the wall. A channel is located between the wall and the central plug. The channel extends substantially from one end to the other end of the cooling chamber. In one embodiment of the invention the channel is formed from a series of axially staggered channel walls which are arranged to provide a continuous flow path for the channel.

An inlet conduit is formed in one end of the cooling chamber and is operative for channeling fluid from outside the cooling chamber into the channel.

An outlet conduit is formed in one end of the cooling chamber, preferably the same end of the cooling chamber as the first conduit. The outlet conduit is operative for channeling fluid from the channel out of the cooling chamber.

The channel can be formed on either the side wall of the housing or on the central plug.

The foregoing and other features of the invention and advantages of the present invention will become more apparent in light of the following detailed description of the preferred embodiments, as illustrated in the accompanying figures. As will be realized, the invention is capable of modifications in various respects, all without departing from the invention. Accordingly, the drawings and the description are to be regarded as illustrative in nature, and not as restrictive.

### BRIEF DESCRIPTION OF THE DRAWINGS

For the purpose of illustrating the invention, the drawings show a form of the invention which is presently preferred. However, it should be understood that this invention is not limited to the precise arrangements and instrumentalities shown in the drawings.

FIG. 1A is an isometric view of a mold assembly for an injection mold machine.

FIG. 1B is an isometric view of the upper half mold illustrating a complex, irregular shaped mold cavity.

FIG. 2 is an exploded isometric view of an inner mold core according to one embodiment of the present invention.

FIG. 3 is a front view of the inner mold core illustrating one open end of the core.

FIG. 4 is an isometric view of the inner mold core of FIG. 2 with the external surface of the core shown in phantom.

FIG. 5 is a section view of the inner mold core illustrating a portion of the inner channels as well as a portion of a central plug.

FIGS. 6 and 7 are section views of the inner mold core taken along lines 6-6 and 7-7, respectively, in FIG. 5.

FIG. 8 is a partial section view of one end of the inner mold core of FIG. 2.

FIG. 9 is a section view taken along lines 9-9 in FIG. 8.

FIG. 10A is a front view of an alternate embodiment of the inner mold core.

FIG. 10B is side view of the embodiment of the inner mold core shown in FIG. 10A.

FIG. 10C is a cross-section view of the inner mold core shown in FIG. 10A, taken along lines 10A-10A.

FIG. 11A is an isometric view of a third embodiment of the inner mold core.

FIG. 11B is a front view of the embodiment of the inner mold core shown in FIG. 11A.

FIG. 11C is a cross-sectional view of the embodiment of inner mold core shown in FIG. 11B taken along lines 11C-11C.

### DETAILED DESCRIPTION OF THE PREFERRED EMBODIMENTS

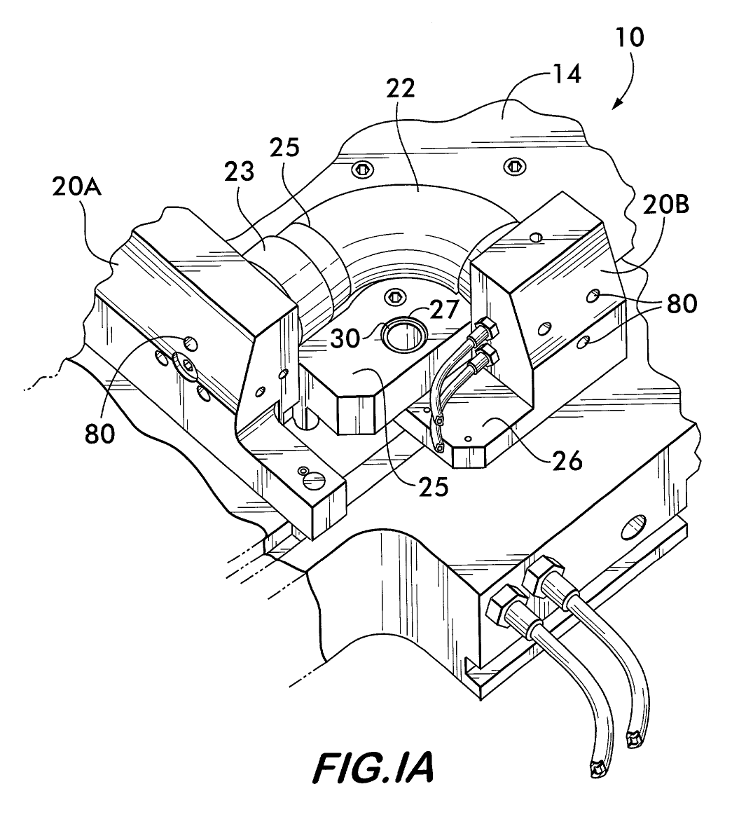

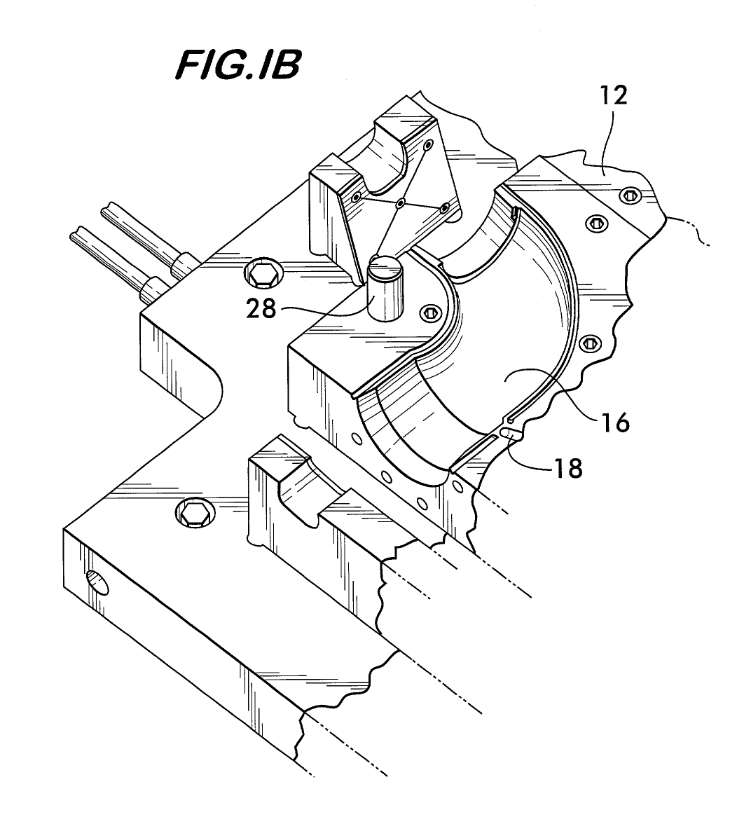

Referring now to the drawings wherein like references numerals identify similar elements throughout the views, one preferred embodiment of a mold is shown for use in forming a hollow curved injection molded part. FIG. 1A illustrates part of a mold 10 operative for forming the injected molded part. While the mold illustrated is for injection molding, other types of molds may be used that incorporate the features and aspects of the current invention. The mold 10 includes an upper mold half 12 and a lower mold half 14. For the sake of simplicity, the upper mold half is removed from FIG. 1A exposing the lower mold half 14 and an inner mold contoured core 22 and a straight mold core 23. The lower mold half 14 operates in combination with the upper mold half 12, and the mold cores 22, 23 to define a mold cavity. Specifically, in the illustrated embodiment, the mold halves 12, 14 each include a cavity portion 16 which, when the mold halves are combined, define the outer contour of a pipe elbow, in this case a 90° degree elbow similar to the type shown in U.S. Pat. Nos. 6,179,343. The upper mold half 12 is shown inverted in FIG. 1B illustrating the curved shape of the mold cavity portion 16 in detail. Runner 18 (shown partially in FIG. 1B) extend through either or both of the mold halves 12, 14 and function as channels or conduits for conveying a molten material into the cavity formed by the mold halves.

The mold 10 preferably includes at least one end plug or core carrier which is operative for holding the mold cores and sealing at least one of the open ends of the mold 10. Contrary to a mold for making a solid molded part, a mold for making a hollow part requires a core that is located between the portions of the mold that define the exterior of the formed shape. In the illustrated embodiment, the core includes the inner mold core 22 and straight mold core 23, which are located between the mold halves 12, 14. The inner and straight mold cores 22, 23 each have a outer surface or contour 24 which defines the interior surface of the molded part. In the presently illustrated embodiment, the core contour 24 of the combination of the inner mold core 22 and straight mold core 23 defines the shape of the inner surface of the molded elbow. The cores 22, 23 are positioned within the mold cavity so as to abut one another at junction 25.

In order to locate the straight mold core 23 and the inner mold core 22 within the mold halves 12, 14, the mold cores are attached to the core carriers 20. Specifically, as shown in FIG. 1A, the straight mold core 23 is attached to a first core carrier 20A. The core carrier 20A positions the straight mold core within the cavity formed by the upper and lower mold halves 12, 14. Similarly, the inner mold core 22 is preferably mounted to a second core carrier 20B. Like with the first core carrier, the second core carrier 20B positions the inner mold core 22 at a specific location within the mold cavity between the upper and lower halves. A mechanism, such as an actuator, is used to translate one or more of the core carriers 20, along with its associated core, toward and away from the mold halves 12, 14.

The cores are preferably removably mounted to their respective core carriers 20A, 20B. Specifically, each core carrier includes a recess within which an end portion of the core seats. Fasteners (not shown) extend through holes 80 formed in the core carriers and thread into the core.

As should be apparent from the figures, in the case of a non-linear or irregularly shaped inner mold core 22, it is not possible to simply linearly insert and retract the inner mold core 22 in an axial direction. Instead, for non-linear shaped hollow items, the inner mold core 22 must be extracted and inserted in a prescribed manner, such as along an arcuate path.

As shown in the embodiment illustrated in FIG. 1A, the straight shape of the straight mold core 23 permits linear extraction and insertion of the core into the mold cavity. The curved inner mold core 22, however, does not. In order to translate the inner mold core 22 into and out of the mold cavity, the second core carrier 20B is mounted to or includes a base 26 which is pivotally attached to the mold apparatus. More specifically, the low mold half 14 includes a pivot hole 27 which extends through a base 25 of the lower mold half. The second core carrier base 26 is located beneath the lower mold half 14 and includes a hollow tubular pin 30 that extends upward through the pivot hole. The upper mold half 12 (FIG. 1B) includes a pin 28 which, in addition to functioning as a locator pin for aligning the upper and lower mold halves 12, 14, also pivotally engages with the tubular pin 30 when the upper mold half 12 is placed on top of the lower mold half 14. The second core carrier 20B, thus, is pivotally attached to the upper and lower mold halves 12, 14.

The second core carrier 20B pivots about the pivot pin 28, which, in turn, pulls the inner mold core 22 out of the mold halves 12, 14 along an arcuate path defined by the radial distance from the inner mold core 22 to the pivot pin 28.

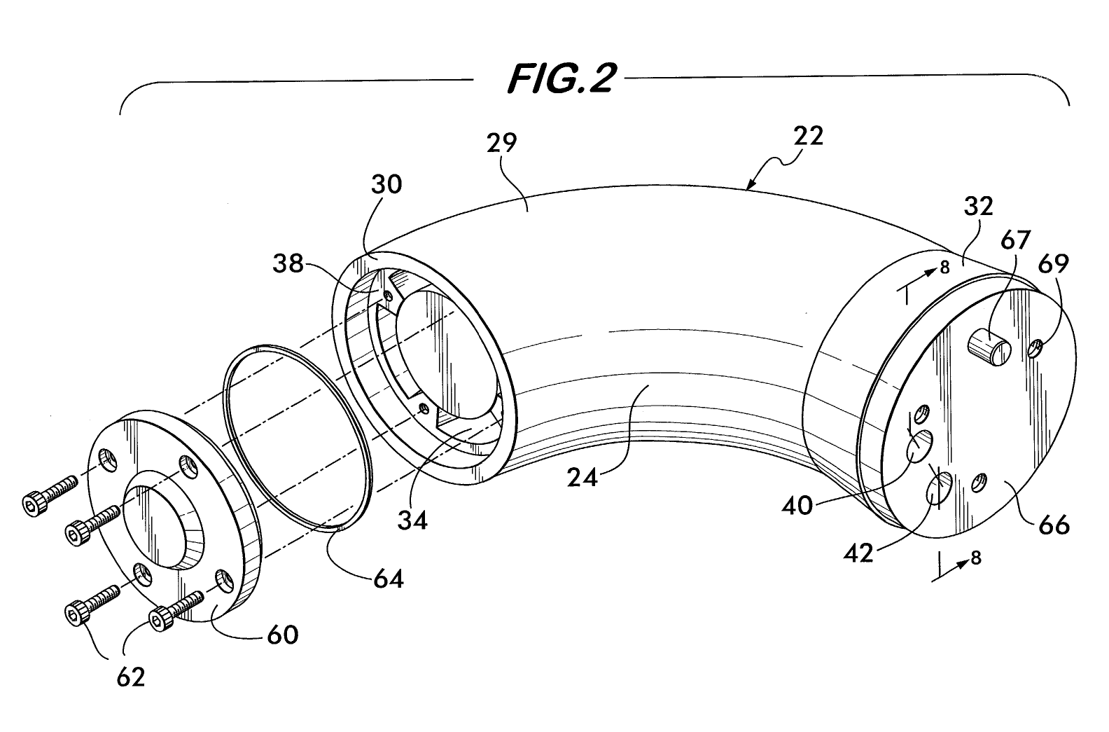

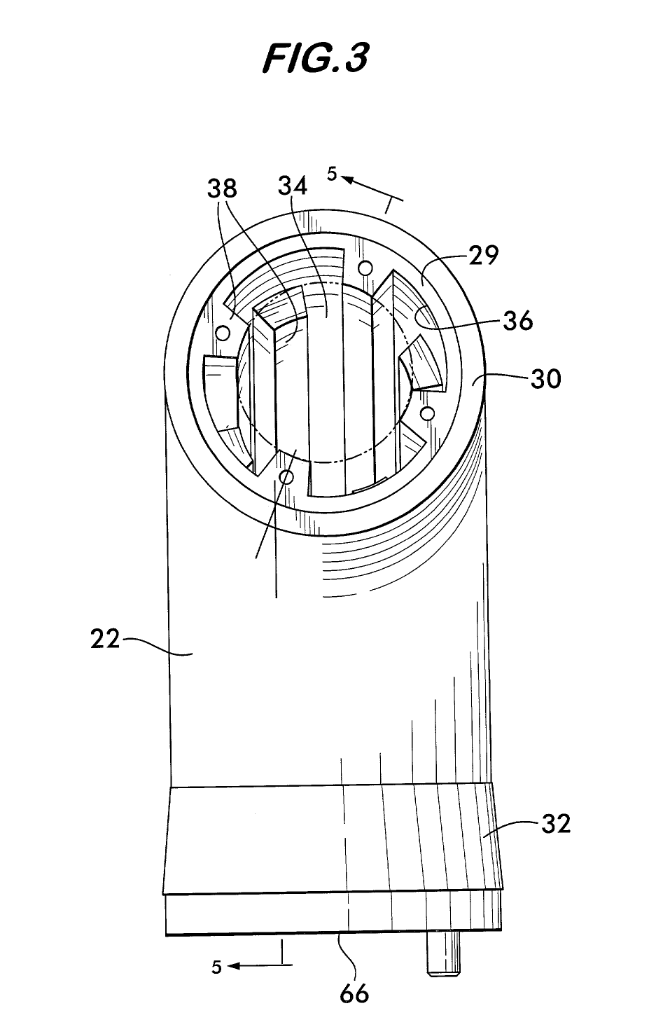

In addition to defining the interior of the curved portion of the molded part, the inner mold core 22 also provides cooling of the interior of the molded part. Thus, the inner molded core 22 acts as a heat exchanger for removing heat from the molten material, thereby accelerating the cooling process. Referring now to FIGS. 2 and 3, the inner mold core 22 is shown in more detail. The inner mold core 22 includes a side wall 29, a first end 30 and a second or shut-off end 32. As can be seen in the figures, the inner mold core 22 is a partially hollow housing with an internal cooling chamber that allows for flow of cooling fluid through the inner mold core 22 for reducing the temperature of the inner mold core 22. More particularly, the inner mold core 22, includes a series of channels 34 which are formed on or in, and extend along at least a portion of, the inner surface 36 of the inner mold core 22. The channels 34 are defined by raised channel walls 38 which project radially inward from the inner surface 36. As will be discussed in more detail below, the axial length of the walls is such that the channels 34 preferably do not extend completely from one axial end of the housing to the other.

As shown in FIG. 2, the first end 30 is closed off by a cap 60 which is attached to the first end by one or more fasteners 62. Specifically, a series of bolts thread into the walls 38 in the inner mold core 22 in order to attach the first cap 60 to the inner mold core 22. An O-ring or similar seal 64 may be inserted between the first cap 60 and the first end 30 to prevent fluid leakage.

The opposite end of the inner mold core 22 is formed with a integrally molded shut-off or closed end 32. The shut-off 32 includes a bottom surface 66 which is designed to mount to the second core carrier 20B. A guide or alignment pin 67 engages with a recess on the second core carrier 20B. As discussed above, fasteners (not shown) extend through holes formed in the second core carrier 20B and engage with threaded holes 69 in the bottom surface 66. While the preferred embodiment uses an integral shut-off end 32 on the mold core 22, it is also contemplated that the shut-off end can be formed as a separate end cap that is attached to the remainder of the mold core. The inner mold core can be made from any suitable material. Preferably it is made from metal, such as steel, stainless steel, aluminum or bronze.

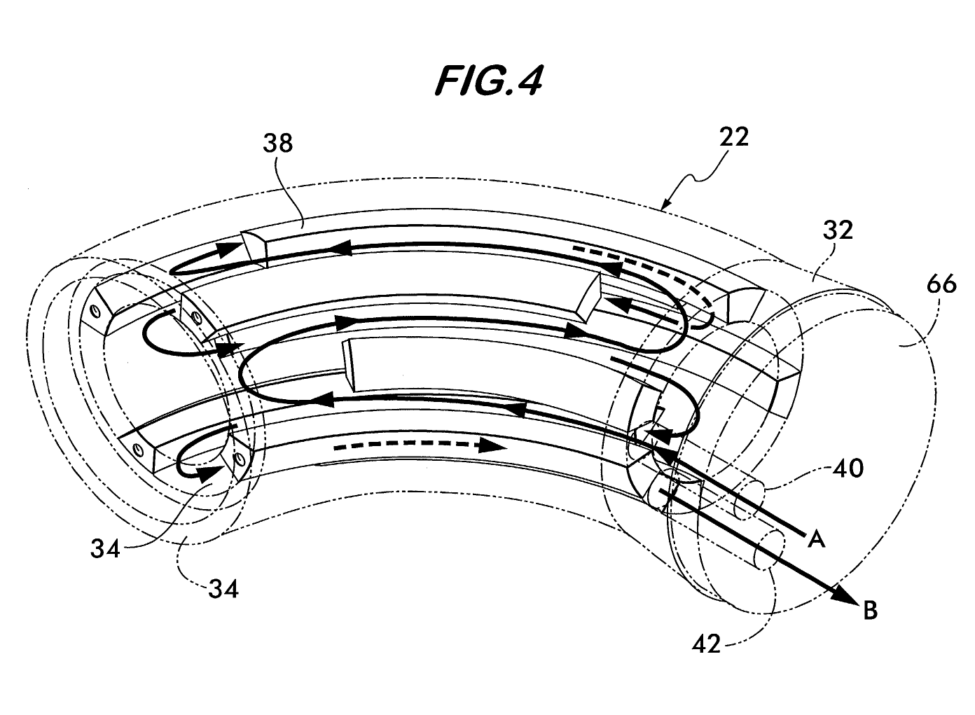

Referring now to FIG. 4, an isometric view of the inner mold core 22 is illustrated with the exterior of the core shown in phantom so that the length and arrangement of the channels 34 and the flow through the inner mold core 22 can be seen. As shown, the walls 38 that form the channels 34 do not extend along the entire length of the inner mold core 22. Instead, they are arranged such that the ends of adjacent walls are axially staggered, thus forming one continuous channel along the inner surface 36 of the core. That is, the series of channels 34 are in fluid communication with one another providing an uninterrupted passage. Thus, as shown by the arrow in FIG. 4, one continuous flow of fluid is created around the inner peripheral surface from point A to point B.

The inner mold core 22 also includes an inlet conduit 40 and an outlet conduit 42. The inlet conduit 40 is preferably formed in the shut-off end 32 and communicates with one end of the continuous channel 34. The outlet conduit 42 also is preferably formed in the shut-off end 32 and communicates with the opposite end of the continuous channel 34. While the inlet and outlet conduits 40, 42 are both shown adjacent to one another and on the same side of the inner mold core 22, it is also contemplated that the conduits can be spaced apart from one another and/or located on opposite sides of the core 22.

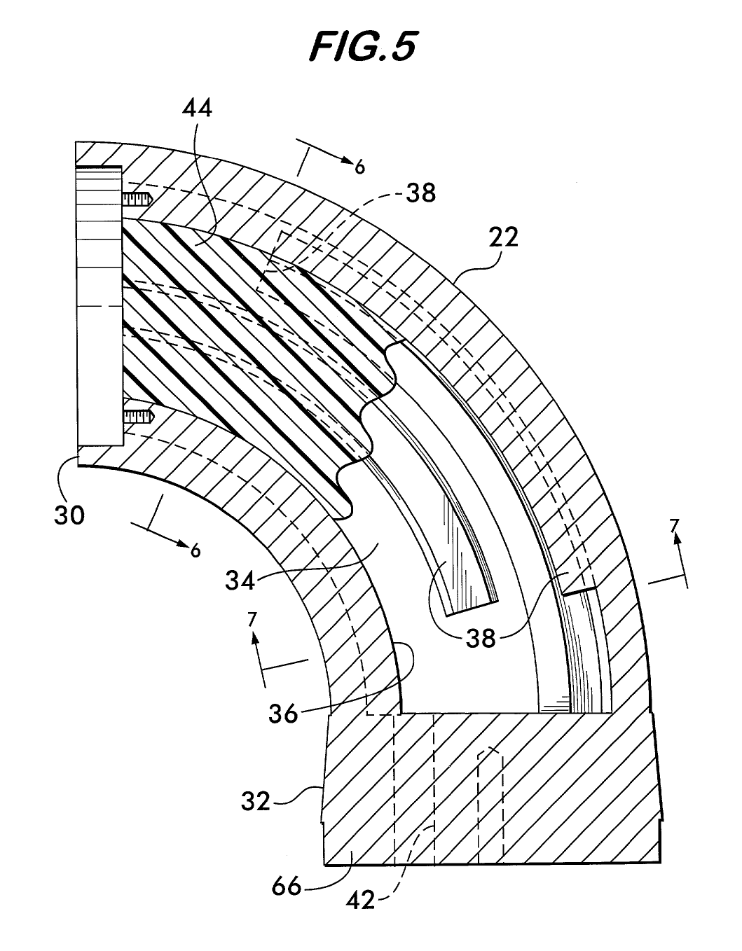

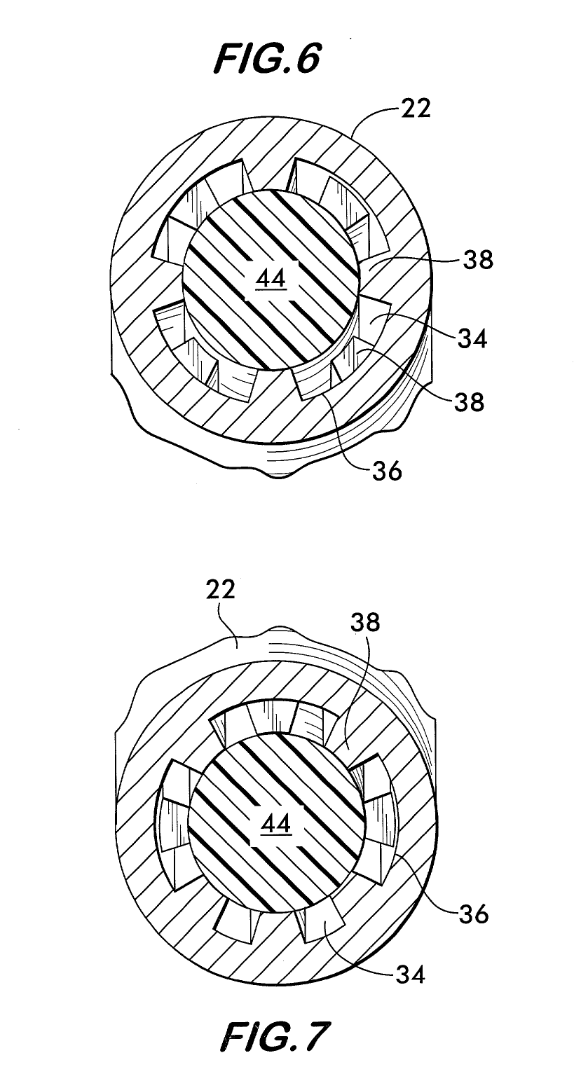

Referring now to FIGS. 5 through 7, several cross-sections of the inner mold core 22 are shown. From these cross-sections, the staggering of the channels 38 can be readily understood. Also shown in the figures is a central plug 44 which is located within the inner mold core 22. The central plug 44 extends through the interior of the inner mold core 22 and contacts the radially inward ends of the walls, thus substantially sealing adjacent channels from exchanging fluid except at the ends of the channels 34. In the illustrated embodiment, the central plug 44 is substantially cylindrical in shape with a curvature that matches with the curvature of the inner mold core 22. More importantly to provide good sealing, the curvature or shape of the central plug 44 should conform substantially to the location of the radially inward ends of the walls 38. In order to maximize the sealing provided by the contact between the walls 38 and the plug 44, the radially inward ends of the walls 38 may include a complementary contour to that of the external surface contour of the central plug 44 (i.e., have a slightly concave shape to match the cylindrical external surface of the plug 44.)

Although the central plug 44 is shown as being cylindrical, any other suitable shape can be used provided a sufficient amount of sealing is achieved so that the majority of the fluid flowing in the channel 34 flows along the entire length of the channel. It is also contemplated that all or a portion of the channels 34 could be formed in the central plug instead of or in addition to the inner mold core 22. Also, the inlet conduit 40 and/or outlet conduit 42 could be formed in the central plug 44. The conduits would channel the fluid flow toward and away from the channels 34 in the inner mold core 22. The central plug 44 can be made from any suitable material, such as plastic or metal and can include a sealant coating. In one preferred embodiment, the central plug 44 is made from neoprene rubber.

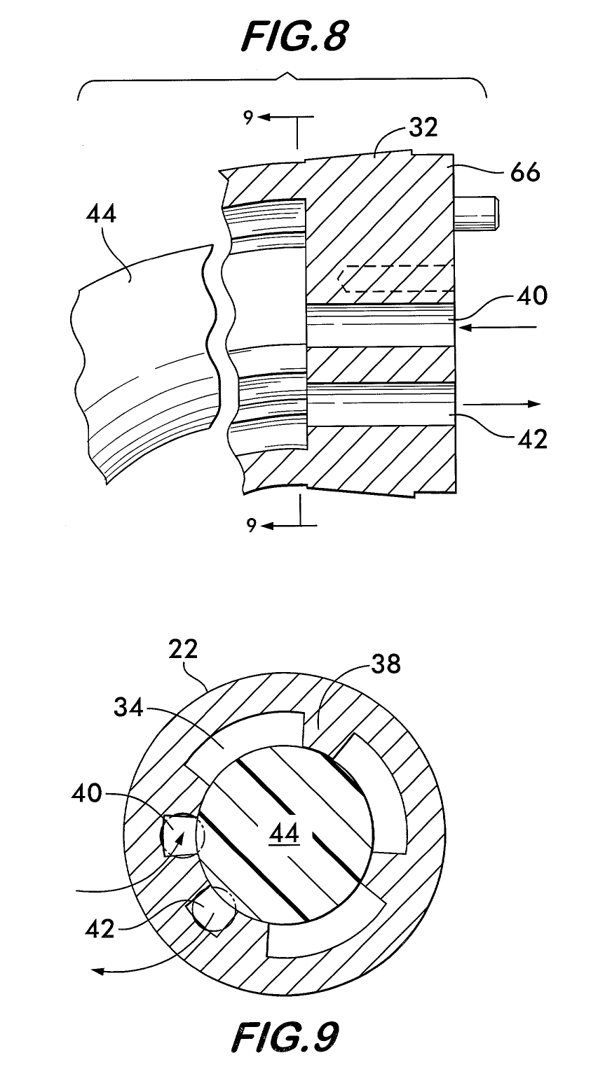

FIGS. 8 and 9 illustrate the shut-off end 32 of the inner mold core 22 in more detail, clearly depicting the location of the inlet conduit 40 and outlet conduit 42 (shown in phantom in FIG. 9.)

The inner mold core 22 incorporates a novel cooling mechanism for molding curved and other irregularly shaped components. The flow of a cooling medium through the mold provides substantially uniform and efficient cooling of the inner mold core 22, and thus the interior of the molded part. Any suitable cooling medium can be used such as water or a water/glycol mixture. Since the channels are connected to one another to form a single continuous channel 34, a single fluid inlet is needed. It is contemplated that more than one inlet conduit may be needed. In those cases, the channels would be arranged and interconnected as needed to provide sufficient cooling for the part being molded.

Also, while the present invention depicts the inner mold core 22 as having the molded in channels 34, it is also contemplated that the present invention can be used to form mold halves 12, 14.

Additionally, while the illustrated embodiment uses two separate inner molds (i.e., a straight mold core and an inner curved mold core), it is also contemplated that one combined mold can be made in accordance with the present invention.

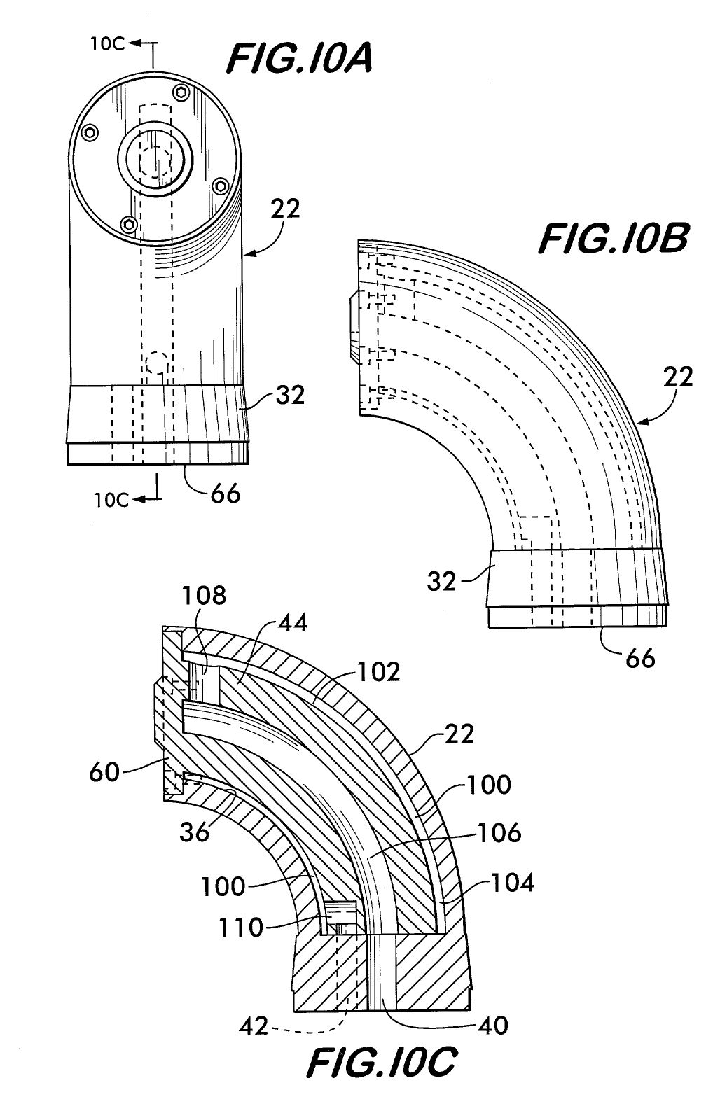

Referring now to FIGS. 10A through 10C, a second embodiment of the invention is shown. In this embodiment, the central plug 44 has a series of contoured channels 100 formed on its outer surface 102. As with the prior embodiment, the channels 100 are defined by a series of walls 104 which are staggered in length, thus providing a continuous channel 100 around the outside periphery of the central plug 44. In this embodiment, there is no need for the inner mold core 22 to have channels formed in it. Instead, the inner mold core 22 can have a smooth inside surface 36 that, operating in combination with the channels 100 on the central plug 44, defines the passages for channeling the coolant from the inlet conduit 40 to the outlet conduit 42.

In the illustrated configuration, the central plug 44 is shown formed integral with the cap 60 that attaches to the first end 30. Of course, the central plug could be attached separately to the cap 60. The opposite end of the central plug 44 abuts the shut-off end 32 of the inner mold core 22. In this embodiment, the inlet conduit 40 is centrally located and is aligned and in fluid communication with an inner conduit or passage 106 formed in the central plug 44. A radially outwardly extending inlet channel 108 in the central plug 44 directs fluid flow from the inner passage 106 to the beginning of the continuous channel 100. The end of the continuous channel 100 is in fluid communication with the outlet conduit 42 through an outlet channel 110. It is contemplated that the channel 100 can be made up of more than one channel and in any configuration to obtain the desired cooling.

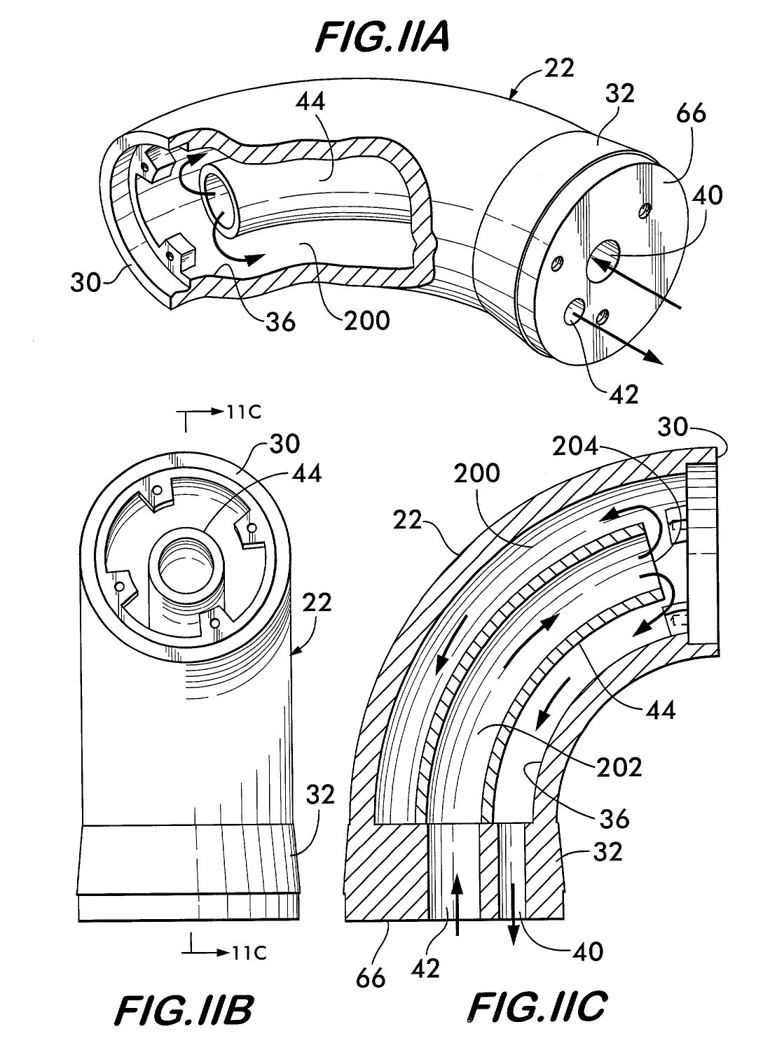

Referring now to FIGS. 11A through 11C, a third embodiment of the invention is illustrated. In this embodiment, the inner mold core 22 is again hollow, defining an interior cooling cavity 200. The central plug 44 is a hollow tubular member that is preferably formed integral with or attached to the shutoff end 32. The central plug 44 is aligned with the inlet conduit 40 in the shutoff end 32 and includes an inner passage 202 for channeling fluid from the inlet conduit 40 to a distal end 204. The distal end 204 of the central plug 44 is located at a position inside the inner mold core 22 spaced apart from the first end 30 and the cap 60. As shown by the arrows in FIGS. 11A and 11C, cooling fluid flows from the inlet conduit 40 though the passage 202 out of the distal end 204 of the central plug 44 and back out of the outlet conduit 42. In this embodiment, the entire cavity within the inner mold core 22 is the channel for conveying cooling water along the inside surface 36 of the inner mold core 22.

It is also contemplated that a bubbler fitting could be attached to inlet conduit 40 and the central plug 44 and the outlet conduit 42 removed. Bubbler fittings are well known in the art and, therefore, no further discussion is needed.

Furthermore, while the illustrated embodiments have shown the channel weaving axially from one end to the other, it is also contemplated that the channel could be formed as a continuous spiral around the circumference of the central plug or inner mold core from one end to the other.

The present invention as described above provides a novel mold core for providing uniform and efficient cooling of irregularly shaped injection molded components. It can also be used for regularly shaped components where the cooling chamber or channels are difficult or impossible to machine with metal working machinery. The features of the present invention can also be used on external molds for providing uniform and consistent cooling of the mold cavities of a molded component.

The mold can be made from any suitable process which accommodates non-linear, irregular or curved shapes. Preferably, the mold is formed using a casting process using a 3-D model. There are many suitable casting processes that can be used. For example, the present invention can be formed using a printer lay-up process that forms a disposable model from a 3-D computer model of the mold. The disposable model is then used to formed the final cast mold. Other techniques, such as stereolithography and powder sintering can be used to form the cast mold from a 3-D computer model. Those skilled in the art would be able to select the casting process to use depending on the shape and type of mold desired.

The present invention may be embodied in other specific forms without departing from the spirit or essential attributes thereof and, accordingly, reference should be made to the appended claims, rather than to the foregoing specification, as indicating the scope of the invention.

What is claimed is:

1. A mold for use in an injection mold assembly, the mold operative for defining at least a portion of a surface contour of an injection molded part, the mold comprising:
a mold member having a cast internal cooling chamber, the cooling chamber having at least one mold wall with a first surface on one side of the wall and a second surface on the opposite side of the wall from the first surface.

2. A mold according to claim 1, wherein the first and second surfaces have substantially complementary contours.

3. A mold according to claim 1, wherein the mold wall of the cooling chamber has a substantially uniform wall thickness.

4. A mold according to claim 1, wherein the mold wall of the cooling chamber has a non-linear shape.

5. A mold according to claim 4, wherein the mold wall of the cooling chamber is substantially in the shape of an elbow.

6. A mold according to claim 1, further comprising a central plug located inside the cooling chamber and spaced apart from the second side of the wall.

7. A mold according to claim 1, further comprising a channel located in the cooling chamber and substantially extending from one end to the other end of the cooling chamber.

8. A mold according to claim 7, further comprising an inlet conduit formed in one end of the cooling chamber for channeling fluid from outside the cooling chamber into the channel; and
an outlet conduit formed in one end of the cooling chamber for channeling fluid from the channel out of the cooling chamber.

9. A mold according to claim 8, wherein there are at least two channel walls formed on the second wall, the two walls defining the channel.

10. A mold according to claim 8, wherein there are a plurality of substantially parallel channel walls formed on and extending away from the second surface of the wall, each channel wall having an axial length, each channel wall being axially staggered from an adjacent wall so as to define channel portions, wherein the channel is formed by the channel portions, each portion being in fluid communication with an adjacent portion so as to define a continuous fluid path that extends along substantially the entire wall between the first and second ends of the cooling chamber.

11. A mold according to claim 10, wherein the inlet conduit is in fluid communication with a first end of the channel and the outlet conduit is in fluid communication with a second end of the channel.

12. A mold according to claim 11, wherein the first and second ends of the channel are located adjacent to the second end of the chamber.

13. A mold according to claim 1, further comprising a central plug located inside the cooling chamber and spaced apart from the second side of the wall,
wherein there are a plurality of substantially parallel channel walls formed on and extending away from the second surface of the wall, each channel wall having an axial length, each channel wall being axially staggered from an adjacent wall so as to define channel portions, wherein the channel is formed by the channel portions, each portion being in fluid communication with an adjacent portion so as to define a continuous fluid path that extends along substantially the entire wall between the first and second ends of the cooling chamber,
wherein the inlet conduit is located in the second end of the chamber; and
wherein the central plug has a first end which is located adjacent to the first end of the chamber and a second end located adjacent to the second end of the chamber, the central plug including a passage that extends into the central plug from the second end of the central plug, the passage connecting to the channel, the passage being in fluid communication with the inlet conduit.

14. A mold according to claim 13, wherein the passage extends completely to the second end of the central plug, and wherein the outlet conduit is formed in the second end of the chamber.

15. A mold according to claim 14, wherein the central plug is formed integral with the second end of the chamber.

16. A mold according to claim 6, wherein there are a plurality of substantially parallel channel walls formed on and extending away from the central plug and toward the wall, each channel wall having an axial length, each channel wall being axially staggered from an adjacent wall so as to define channel portions, wherein the channel is formed by the channel portions, each portion being in fluid communication with an adjacent portion so as to define a continuous fluid path from substantially one end of the cooling chamber to the other.

17. A mold according to claim 16, wherein the inlet conduit is in fluid communication with one end of the channel and the outlet conduit is in fluid communication with the other end of the channel.

18. An inner mold core for use in an injection mold assembly, the inner mold core having an external surface with a contour that defines at least a portion of an interior contour of an injection molded part, the inner mold core adapted to be located between at least two mold halves, the inner mold core comprising:
a hollow cast housing including at least one side wall, the side wall having an external surface with a non-linear contour and an internal surface, a first open end, and a second substantially closed end, the side wall and the second end defining a cooling chamber, the side wall having a substantially uniform thickness.

19. An inner mold core according to claim 18, further comprising a central plug located inside the cooling chamber and spaced apart from the side wall, and a channel located between the side wall and the central plug and extending substantially from the closed end to the open end of the housing.

20. An inner mold core according to claim 18, further comprising an inlet conduit formed in one end of the housing for channeling fluid from outside the housing into the channel; and
an outlet conduit formed in one end of the cooling chamber for channeling fluid from the channel out of the housing.

21. An inner mold core according to claim 18, further comprising at least two channel walls formed on the side wall inside the housing, the spacing of the channel walls defining a channel.

22. An inner mold core according to claim 21, wherein there are a plurality of substantially parallel channel walls formed on and extending inward from the side wall, each channel wall extending axially along a portion of the inside surface of the side wall and having ends which are axially staggered from the ends on adjacent walls, wherein adjacent pairs of channel walls define channel portions, the staggering of the ends of the channel walls permitting fluid communication between adjacent channel portions thereby defining a continuous fluid path that extends along substantially the entire inside surface between the first and second ends of the housing.

23. An inner mold core according to claim 21, wherein the inlet conduit is in fluid communication with a first end of the channel and the outlet conduit is in fluid communication with a second end of the channel.

24. An inner mold core according to claim 23, wherein the first and second ends of the channel are located adjacent to the second end of the housing.

25. An inner mold core according to claim 19, wherein the inlet conduit is located in the second end of the housing; and wherein the central plug has a first end which is located adjacent to the first end of the housing and a second end located adjacent to the second end of the housing, the central plug including a passage that extends at least partially though the central plug from the second end of the central plug, the passage connecting to the channel and being in fluid communication with the inlet conduit.

26. An inner mold core according to claim 25, wherein the passage extends completely to the second end of the central plug, and wherein the outlet conduit is formed in the second end of the housing.

27. An inner mold core according to claim 19, wherein the central plug is formed integral with the second end of the housing.

28. An inner mold core according to claim 19, wherein there are a plurality of substantially parallel channel walls formed on and extending outward from the central plug and toward the side wall, each channel wall extending axially along a portion of the central plug and having ends which are axially staggered from the ends on adjacent walls, wherein adjacent pairs of channel walls define portions of the channel, the staggering of the ends of the channel walls permitting fluid communication between adjacent channel portions, the combination of the channel portions forming the channel with a continuous fluid path that extends along substantially the entire inside surface between the first and second ends of the housing.

29. A inner mold core for use in an injection mold assembly, the inner mold core having an external surface with a contour that defines at least a portion of an interior contour of an injection molded part, the inner mold core adapted to be located between at least two mold halves, the inner mold core comprising:
a hollow cast housing including at least one side wall, the side wall having an external surface with a contour and an internal surface, a first open end, and a second substantially closed end, the side wall and the second end defining a cooling chamber, the side wall having a substantially uniform thickness.

30. An inner mold core according to claim 29, further comprising a central plug located inside the cooling chamber and spaced apart from the side wall.

31. An inner mold core according to claim 30, further comprising:
at least one channel located between the side wall and the central plug and forming a continuous fluid flow path substantially between the closed end and the open end of the housing, the channel being formed by at least one channel wall that extends between the side wall and the central plug, the channel wall forming a series of substantially parallel channel portions;
an inlet conduit formed in the second end of the housing and in fluid communication with a first end of the channel for permitting fluid flow from outside the housing into the channel; and
an outlet conduit formed in the second end of the housing and in fluid communication with a second end of the channel for permitting fluid flow from the channel out of the housing.

32. A mold according to claim 1, wherein the mold is made according to a casting process comprising the steps of:
forming a three-dimensional model of the mold, the mold including a cooling chamber;
forming an interim mold from the three-dimensional model; and
forming the final cast mold from the interim mold.
